(19) United States
(12) Patent Application Publication
(10) Pub. No.: US 2026/0352976 A1
(43) Pub. Date: Nov. 5, 2026

(54) SENSOR DEVICE, DATA STRUCTURE, AND INFORMATION PROCESSING DEVICE

(71) Applicant: SONY SEMICONDUCTOR SOLUTIONS CORPORATION, KANAGAWA (JP)

(72) Inventor: TAKASHI SARUTA, KANAGAWA (JP)

(21) Appl. No.: 19/488,092

(22) PCT Filed: May 24, 2024
(86) PCT No.: PCT/JP2024/019229

§ 371 Date: Nov. 26, 2025

(30) Foreign Application Priority Data
Jun. 14, 2023 (JP) 2023-097461

(51) Int. Cl. H04N 25/706; H04N 25/77

(52) U.S. Cl. CPC H04N 25/706; H04N 25/77

(57) ABSTRACT

A sensor device includes a pixel array unit in which pixels are two-dimensionally arrayed, a determination processing unit that determines whether or not every line data output from the pixel array unit is valid line data to be processed in image processing in a subsequent stage, an additional information generation unit that generates additional information on a basis of a result of the determination by the determination processing unit, an output data generation unit that generates output data for every line by using the line data and the additional information, and an output unit that outputs the output data.

### TECHNICAL FIELD

The present technology relates to a technology of a sensor device, a data structure, and an information processing device for data for every line output from a pixel array unit.

### BACKGROUND ART

A system that performs object detection, defect detection, and the like by performing image processing for image data is known. In such a system, it may be necessary to perform image processing efficiently.

For example, Patent Document 1 below discloses a technology of adding a flag indicating a shift direction of an image to image data.

### CITATION LIST

### Patent Document

Patent Document 1: Japanese Patent Application Laid-Open No. 2000-004404

### SUMMARY OF THE INVENTION

### Problems To Be Solved By The Invention

Incidentally, high-speed image sensors exceeding 30 fps and 60 fps have become widespread. In a case where image processing is performed on a frame image as such image data that is output at a high speed, it is desirable to reduce the amount of calculation in the image processing.

The present technology has been made in view of such a problem, and an object thereof is to reduce a processing load of image processing for a frame image.

### Solutions To Problems

A sensor device according to the present technology includes a pixel array unit in which pixels are two-dimensionally arrayed, a determination processing unit that determines whether or not every line data output from the pixel array unit is valid line data to be processed in image processing in a subsequent stage, an additional information generation unit that generates additional information on a basis of a result of the determination by the determination processing unit, an output data generation unit that generates output data for every line by using the line data and the additional information, and an output unit that outputs the output data.

Therefore, it is possible to determine whether or not to perform image processing for every line data in an information processing device in a subsequent stage.

A data structure according to the present technology is a data structure of output data output from a sensor device including a pixel array unit in which pixels are two-dimensionally arrayed, and the data structure is generated on a basis of line data output from the pixel array unit and additional information indicating a determination result as to whether every line data is valid line data to be processed in image processing in a subsequent stage.

An information processing device according to the present technology includes a reception processing unit that receives, from a sensor device, output data generated on a basis of line data output from a pixel array unit in which pixels are two-dimensionally arrayed, and additional information indicating a determination result as to whether every line data is valid line data to be processed in image processing in a subsequent stage, a determination processing unit that determines whether or not to execute predetermined image processing for the line data on a basis of the additional information included in the output data received by the reception processing unit, and an image processing unit 15 (15A or 15B) that executes the predetermined image processing for the line data on a basis of a determination result of the determination processing unit.

### BRIEF DESCRIPTION OF DRAWINGS

FIG. 1 is a diagram illustrating a configuration example of a detection system according to the present technology, and is a block diagram illustrating a configuration of a detection system according to first and second embodiments.

FIG. 2 is a diagram illustrating an outline of the detection system.

FIG. 3 is a diagram illustrating an example in which it is determined whether or not a target object is captured for every pixel block region.

FIG. 4 is a diagram for explaining a change in an average luminance value between frames in the pixel block region in which the target object is captured.

FIG. 5 is a diagram illustrating an example of additional information for every line.

FIG. 6 is a diagram illustrating an example of a data structure of output data.

FIG. 7 is a diagram illustrating a data structure of packet data conforming to an SLVS-EC standard.

FIG. 8 is a diagram for explaining that a plurality of pieces of pixel data is stored in a payload region in the packet data.

FIG. 9 is a flowchart illustrating an example of processing executed by the detection system regarding the detection of the target object, the generation of the additional information, and the like.

FIG. 10 is a flowchart illustrating an example of processing executed by an external sensor processing unit.

FIG. 11 is a flowchart illustrating an example of processing executed by the detection system regarding specification of a processing target region and image processing.

FIG. 12 is a diagram for explaining an example in which a valid range and an invalid range are further set in valid line data.

FIG. 13 is a diagram illustrating an example of a signal output to distinguish between a valid range and an invalid range.

FIG. 14 is a diagram for explaining a processing target region set as a processing target range in image processing in a subsequent stage.

FIG. 15 is a block diagram illustrating a configuration of a detection system according to a third embodiment.

### MODE FOR CARRYING OUT THE INVENTION

Hereinafter, embodiments according to the present technology will be described in the following order with reference to the accompanying drawings.
<1. First Embodiment>
<1-1. System Configuration>
<1-2. Procedure of Generating Additional Information>
<1-3. About Output Data>
<1-4. Processing Flow>
<2. Second Embodiment>
<3. Third Embodiment>
<4. Modification>
<5. Summary>
<6. Present Technology>

### 1. First Embodiment

A sensor device 1 according to a first embodiment of the present technology will be described.

The sensor device 1 is included in a camera device 2 and constitutes a detection system S together with an information processing device 3 in a subsequent stage.

### 1-1. System Configuration

The detection system S detects an object to be detected in a captured image obtained by imaging, determines a region to be processed in image processing in a subsequent stage, and performs image processing for a partial region in a frame image FG on the basis of a detection result of the object and a determined region.

The detection system S is applied to, for example, a system that detects a problem of a product, a system that reads a one-dimensional code, a two-dimensional code, or the like attached to an object, or the like.

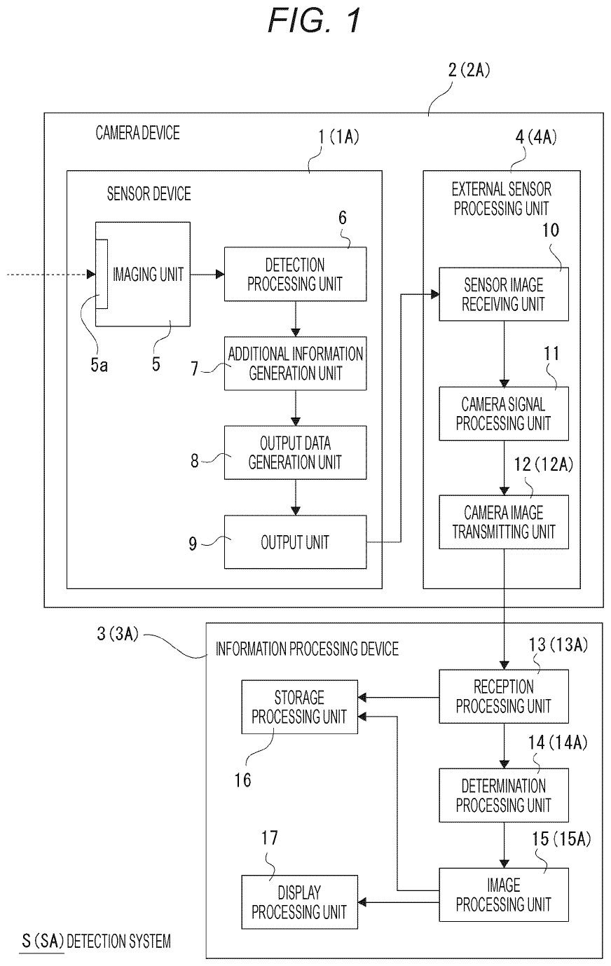

FIG. 1 illustrates a configuration example of the detection system S according to the first embodiment.

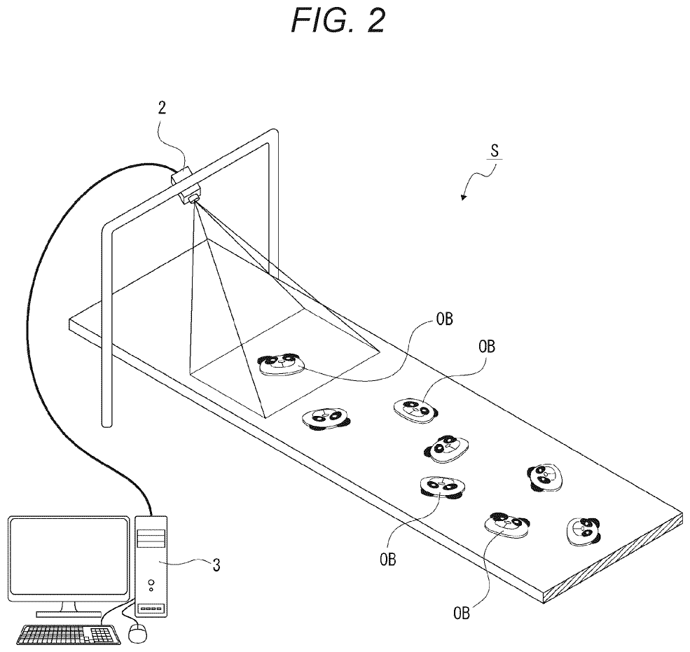

The detection system S includes the camera device 2 and the information processing device 3 (see FIGS. 1 and 2).

The camera device 2 includes the sensor device 1 and an external sensor processing unit 4 in a subsequent stage.

The sensor device 1 is, for example, a charge coupled device (CCD) type or complementary metal oxide semiconductor (CMOS) type image sensor, and includes an imaging unit 5, a detection processing unit 6, an additional information generation unit 7, an output data generation unit 8, and an output unit 9.

The imaging unit 5 includes a pixel array unit 5a in which pixels each having a photoelectric conversion element as a light receiving unit such as a photodiode are two-dimensionally arrayed, and a reading circuit that reads an electric signal obtained by photoelectric conversion from each pixel included in the pixel array unit 5a, and can output the electric signal as imaging data as RAW data.

The imaging data output from the imaging unit 5 is, for example, data for every line obtained by collecting a plurality of pieces of pixel data included in the same row (line). The data for every line is referred to as “line data LD”. Note that, data for one pixel included in the line data LD may be referred to as “pixel data”.

Note that, the line data LD output from the pixel array unit 5a is only required to be not only data such as a color image and a monochrome image but also two-dimensional data having a value for every pixel such as a distance image, EVS data, a heat map image, a spectral image, or a polarized image.

For example, an image processing unit in a subsequent stage can perform image processing for inspecting the quality of merchandise on the basis of the imaging data such as the color image and the monochrome image. Furthermore, the image processing unit in the subsequent stage can perform image processing for detecting a defect (a hole, a chip, or the like) in a shape of merchandise on the basis of the imaging data as the distance image. Moreover, on the basis of the captured data as the heat map image, the image processing unit in the subsequent stage can perform image processing for detecting a degree of doneness of food as the merchandise and the like.

In addition, the image processing unit in the subsequent stage can perform image processing for detecting a problem regarding the color of the merchandise on the basis of the imaging data such as the spectral image and the polarized image.

These types of image processing are merely examples, and other image processing corresponding to various purposes can be performed.

Note that, the image processing unit in the subsequent stage in the present embodiment is included in the information processing device 3 provided outside the camera device 2.

The reading circuit included in the pixel array unit 5a executes, for example, correlated double sampling (CDS) processing, automatic gain control (AGC) processing, and the like on the electric signal obtained by photoelectric conversion, and further performs analog/digital (A/D) conversion processing.

The imaging data after the A/D conversion processing is output to the detection processing unit 6.

Note that, the imaging data provided to the detection processing unit 6 is digital data (RAW data) after the A/D conversion processing output from the imaging unit 5.

Furthermore, data obtained by performing preprocessing or the like on the RAW data may be provided to the detection processing unit 6.

In the preprocessing, clamp processing of clamping black levels of R, G, and B to predetermined levels, correction processing between color channels of R, G, and B, and the like are performed on the imaging data.

The detection processing unit 6 performs processing of detecting a target object OB to be subjected to image processing in the subsequent stage for every line data LD.

Various detection methods by the detection processing unit 6 are conceivable, and for example, detection may be performed for every line data LD. Alternatively, as described later, the detection processing unit 6 may divide data (frame image FG as the RAW data) obtained by collecting each line data LD to form an image of one frame into pixel block regions Ar, and detect the target object OB for every pixel block region Ar.

The additional information generation unit 7 generates additional information AD indicating whether or not the target object OB is included for every line data LD on the basis of a detection result of the detection processing unit 6.

A determination result as the additional information AD can be expressed by 1-bit flag information.

The output data generation unit 8 generates output data OD to be output to the processing unit in the subsequent stage by using the line data LD and the additional information AD. The generated output data OD may be, for example, data conforming to Scalable Low Voltage Signaling (SLVS) standard (including SLVS with Embedded Clock (SLVS-EC) ), data conforming to Mobile Industry Processor Interface (MIPI) standard, or data having other configurations.

The output unit 9 outputs the output data OD generated by the output data generation unit 8 to the processing unit in the subsequent stage, specifically, the external sensor processing unit 4. The output data OD output from the output unit 9 to an outside of the sensor device 1 is data including the line data LD for one line and the additional information AD thereof. That is, the output unit 9 outputs the output data OD by the number of pieces of line data LD for imaging of one frame.

The external sensor processing unit 4 includes a sensor image receiving unit 10, a camera signal processing unit 11, and a camera image transmitting unit 12.

The sensor image receiving unit 10 receives the output data OD as a sensor image output from the sensor device 1, and supplies the output data OD to the camera signal processing unit 11 in a subsequent stage.

The camera signal processing unit 11 performs development processing including the preprocessing described above, synchronization processing, YC generation processing, and the like on the sensor image output from the sensor device 1.

Furthermore, the development processing may include resolution conversion processing, codec processing, and the like as necessary.

In the synchronization processing, color separation processing is performed such that the imaging data for each pixel has all color components of R, G, and B. For example, in a case of an imaging element using a color filter of a Bayer array, demosaicing processing is performed as the color separation processing. In the YC generation processing, a luminance (Y) signal and a color (C) signal are generated (separated) from pieces of imaging data of R, G, and B. In the resolution conversion processing, resolution conversion processing is executed on pieces of imaging data subjected to various types of signal processing.

In the codec processing, for example, encoding processing for recording or communication and file generation are performed on the pieces of imaging data subjected to the above-described various types of processing. In the codec processing, it is possible to generate a file in a format such as, for example, Moving Picture Experts Group (MPEG)-2 or H.264 as a moving image file format. Furthermore, it is also conceivable to generate a file in a format such as Joint Photographic Experts Group (JPEG), Tagged Image File Format (TIFF), or Graphics Interchange Format (GIF) as a still image file.

The camera image transmitting unit 12 performs processing of transmitting image data (camera image data) obtained by the processing of the camera signal processing unit 11 to a device outside the camera device 2. In the present example, the camera image transmitting unit 12 transmits the camera image data to the information processing device 3 included in the detection system S.

Next, a configuration example of the information processing device 3 will be described with reference to FIG. 1.

The information processing device 3 performs predetermined image processing on the camera image data received from the camera device 2. At this time, the information processing device 3 selects a part of the camera image data and performs image processing.

The information processing device 3 includes a reception processing unit 13, a determination processing unit 14, an image processing unit 15, a storage processing unit 16, and a display processing unit 17.

The reception processing unit 13 receives the camera image data from the camera device 2. The received camera image data is supplied to the storage processing unit 16 and stored in a storage unit (not illustrated).

Furthermore, the received camera image data is also supplied to the determination processing unit 14.

The determination processing unit 14 determines a line of an image processing target by using the additional information AD for every line data LD related to the supplied camera image data. That is, the determination processing unit 14 determines whether or not the image processing can be executed for every line data LD in the camera image data.

A determination result is supplied to the image processing unit 15 together with the camera image data.

The image processing unit 15 performs image processing for a region (line) of a processing target in the camera image data on the basis of the determination result of the determination processing unit 14.

As described above, the image processing executed by the image processing unit 15 is processing of detecting the target object OB and determining the presence or absence of a problem such as a defect, processing of detecting and reading a two-dimensional code as the target object OB, or the like.

More specifically, the image processing unit 15 performs the image processing on the line data LD determined to be a target of the image processing on the basis of the additional information AD. In other words, the image processing unit 15 does not perform the image processing on the line data LD determined not to be a target of the image processing on the basis of the additional information AD.

A processing result by the image processing unit 15 is supplied to the storage processing unit 16 and stored in the storage unit (not illustrated).

Furthermore, the image processing unit 15 supplies a result of the image processing to the display processing unit 17. Therefore, it is possible to present the result of the image processing to a user by using the detection system S.

### 1-2. Procedure of Generating Additional Information

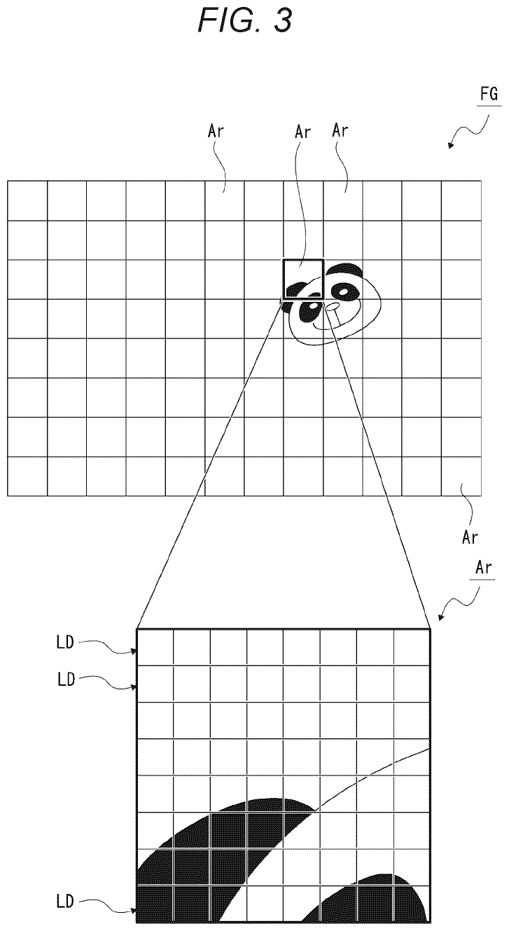

A procedure until the additional information AD is generated will be described with reference to FIG. 3 and the like.

FIG. 3 is an image obtained by capturing the target object OB flowing on a belt conveyor by the camera device 2 illustrated in FIG. 2, and illustrates the frame image FG generated by the line data LD for one frame output from the imaging unit 5.

The detection processing unit 6 divides the frame image FG into a plurality of pixel block regions Ar, and detects the target object OB for every pixel block region Ar. The detection processing unit 6 sets the pixel block region Ar in which the target object OB is captured as a “valid block Bv”, and sets the pixel block region Ar in which the target object OB is not captured as an “invalid block Bi”.

The detection processing unit 6 determines the valid block Bv and the invalid block Bi by using an average luminance value calculated for every pixel block region Ar.

One pixel block region Ar is, for example, a region of 64 pixels in total including 8 pixels in vertical and horizontal directions.

The detection processing unit 6 detects the target object OB at a timing when the line data LD for one frame is received from the imaging unit 5 or at a timing when the line data LD for which processing can be performed on the pixel block region Ar is received from the imaging unit 5. That is, in the example illustrated in FIG. 3, the detection processing may be executed every time all the pieces of line data LD included in the frame image FG are received, or the detection processing may be executed every time eight pieces of line data LD are received.

The detection processing unit 6 compares the average luminance value calculated for the pixel block region Ar with a threshold, and determines the pixel block region Ar as the valid block Bv on the assumption that the target object OB is detected in a case where a deviation between the average luminance value and a reference value is equal to or larger than a predetermined value.

As the reference value used for comparison with the average luminance value, for example, in the present example, it is conceivable to adopt the average luminance value of the pixel block region Ar in which only the belt conveyor appears. Furthermore, the reference value may be different for every pixel block region Ar.

For example, the reference value may be set for every pixel block region Ar by using the frame image FG captured in a state where merchandise or product is not flowing on the belt conveyor.

The pieces of line data LD including a part of one valid block Bv are eight pieces of line data LD in the present example. The eight pieces of line data LD are set as “pieces of valid line data LDv” that are the pieces of line data LD to be subjected to the image processing in the subsequent stage.

The additional information generation unit 7 sets a valid flag Fv as the additional information AD of each of the valid line data LDV.

Note that, other methods for determining the valid block Bv and the invalid block Bi by the detection processing unit 6 are conceivable.

For example, the valid block Bv may be determined on the basis of a change in an average luminance value between a previous frame image FG and a current frame image FG.

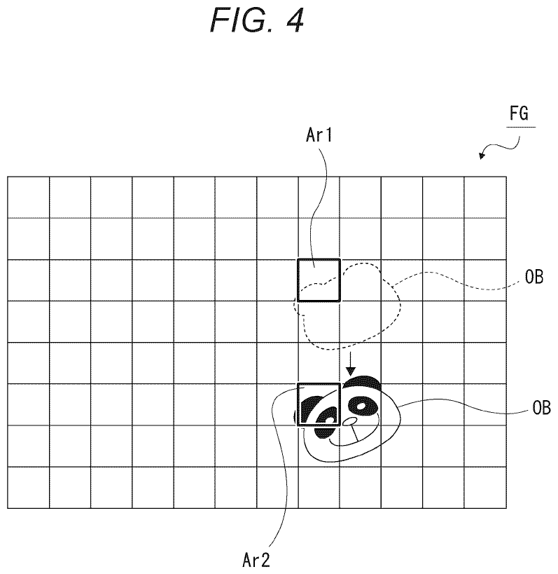

An example is illustrated in FIG. 4. FIG. 4 illustrates the current frame image FG, and a position of the target object OB in the previous frame image FG is indicated by a broken line.

Attention is paid to two pixel block regions Ar1 and Ar2. The pixel block region Ar1 is one of the pixel block regions Ar in which a part of the target object OB is captured in the previous frame image. Furthermore, the pixel block region Ar2 is one of the pixel block regions Ar in which a part of the target object OB is captured in the current frame image FG.

At this time, both the pixel block region Ar1 and the pixel block region Ar2 are the pixel block region Ar in which the average luminance value is changed. Accordingly, the detection processing unit 6 may determine, as the valid blocks Bv, both the pixel block regions Ar1 and Ar2.

Alternatively, the detection processing unit 6 may determine the valid block Bv on the basis of a direction of change in the average luminance value.

For example, consider a case where the target object OB is an object having a luminance value larger than that of black. At this time, the color of the belt conveyor is set to black, and thus, in the pixel block region Ar2 in which a state where the target object OB does not appear is changed to a state where the target object OB appears, the change in the average luminance value is set in a positive direction.

On the other hand, in the pixel block region Ar1 in which a state where the target object OB appears is changed to a state where the target object OB does not appear, the change in the average luminance value is in a negative direction.

Accordingly, the pixel block region Ar in which the average luminance value is changed in the positive direction is determined as the valid block Bv, and thus, only the line data LD in which the target object OB is captured can be determined as the valid line data LDv to be processed.

On the other hand, in a case where the target object OB has a color close to black, the color of the belt conveyor is white, and the pixel block region Ar in which the average luminance value is changed in the negative direction is determined as the valid block Bv. As a result, the appropriate additional information AD can be set.

Furthermore, the frame image FG used in the detection processing unit 6 is RAW data before the synchronization processing. Accordingly, in a case where the color of the target object OB is red, the valid block Bv can be appropriately determined by calculating the change in the average luminance value for red in the pixel block region Ar. At this time, it is desirable to set the color of the belt conveyor such that a luminance value for red in a case where the belt conveyor is captured is different from a luminance value for red in a case where the target object OB is captured.

### 1-3. About Output Data

A detection result of the target object OB for every line data LD is added to the line data LD as the additional information AD. The additional information AD is information indicating the presence or absence of detection and can be expressed by 1-bit flag information.

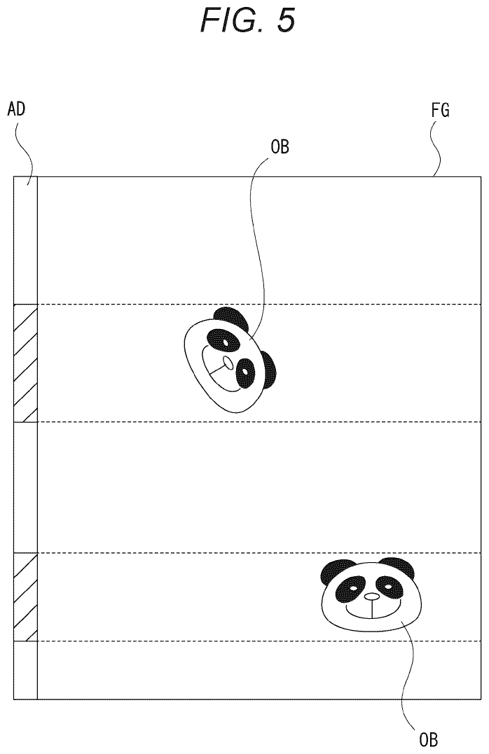

FIG. 5 illustrates an example of the additional information AD. A hatched row is a row in which “1” indicating the valid line data LDv is set as the additional information AD.

Furthermore, an unhatched row is a row in which “0” indicating invalid line data LDi is set as the additional information AD.

The additional information AD as such 1-bit flag information is included in packet data for transmitting the line data LD, and thus, whether or not the line data LD is to be subjected to the image processing can be transmitted to the processing unit in the subsequent stage.

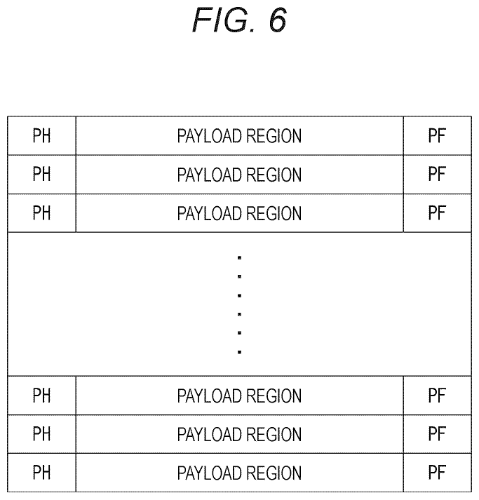

An example of the output data generated by using the line data LD and the additional information AD will be described with reference to FIG. 6.

In various packet data formats, a packet header PH, a payload region, and a packet footer PF are provided for every packet.

For example, one line data LD is included in a payload region of one packet.

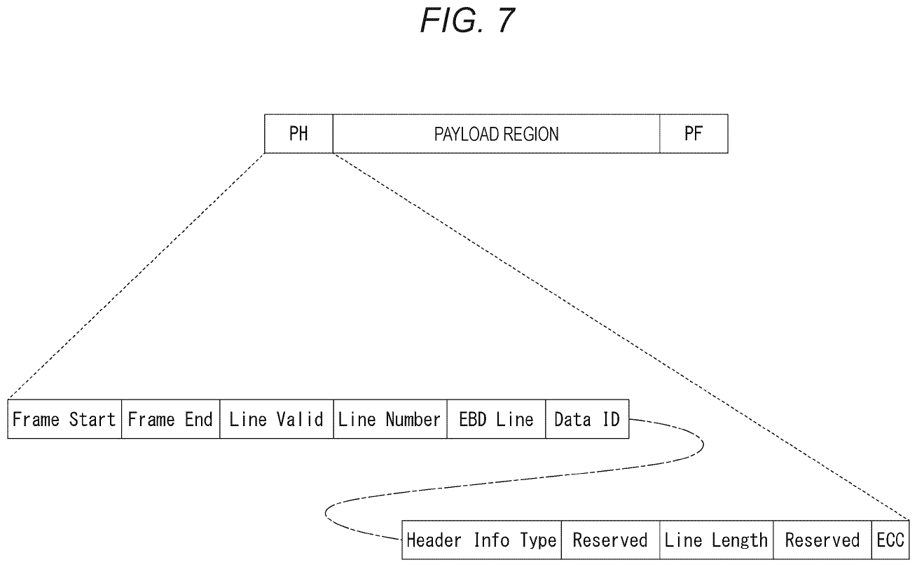

A configuration of the packet header PH varies depending on the specification. For example, in the SLVS-EC standard, “Frame Start”, “Frame End”, “Line Valid”, “Line Number”, “EBD Line”, “Data ID”, “Header Info Type”, “Reserved”, “Line Length”, “Reserved”, “ECC”, and the like are provided in the packet header PH (see FIG. 7).

The line data LD and the additional information AD can be included in the packet data without changing a size of the packet header PH by storing the additional information AD in an unused region, an extended region, specifically, a region set to “Reserved”, or the like among these items.

Furthermore, according to the MIPI specification, the line data and the additional information can be included in, for example, channel information or data type information stored in “Data ID” among “Data ID”, “Word Count”, and “ECC” provided in the packet header PH.

Furthermore, for example, the additional information AD may be stored in a region such as “Word Count”. In the information of “Word Count”, when a size of the pixel array unit 5a is known, since a packet size when one line data LD is transmitted is also known and becomes unnecessary information, the additional information AD can be stored instead.

As described above, the additional information AD which is the 1-bit flag information can be stored in a region different from the line data LD in the packet data.

As another method, a method for including the additional information AD in the line data LD is also conceivable.

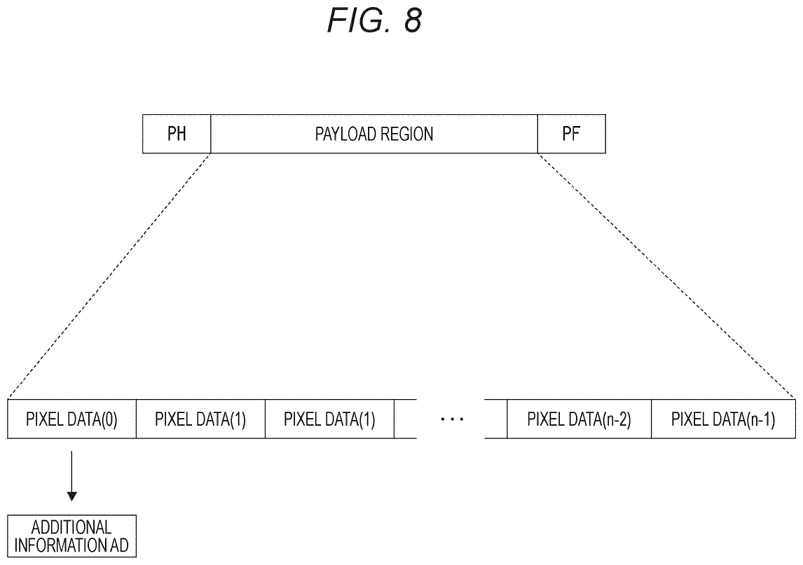

For example, when the size of the pixel array unit 5a in a horizontal direction is n pixels, the line data LD includes n pieces of pixel data (see FIG. 8). Pixel data (0) in the drawing indicates first (head) pixel data, and pixel data (n−1) indicates n-th (last) pixel data.

Here, it is conceivable to replace the pieces of pixel data at both ends of the line data LD with the additional information AD. Furthermore, more preferably, the pixel data in the head of the line data LD is replaced with the additional information AD.

Among the pixels arranged in the same row, a head pixel (a pixel at a left end in the horizontal direction) and a last pixel (a pixel at a right end in the horizontal direction) are pixels in which there is a low possibility that the target object appears when an angle of view of the camera device 2 is appropriately set. Accordingly, among the pieces of pixel data included in the line data LD, the pixel data of such an end pixel is replaced with the additional information AD, and thus, it is possible to transmit both the line data LD and the additional information AD without changing the packet size while maintaining the effectiveness of the image processing in the subsequent stage.

Note that, 1 bit in the pixel data of the head pixel or the last pixel may be handled as the additional information AD. In this case, LSB in the pixel data may be allocated to the additional information AD. Therefore, the influence of the head pixel and the last pixel on the pixel data can be minimized, and the pixel data can be handled as original pixel data.

### 1-4. Processing Flow

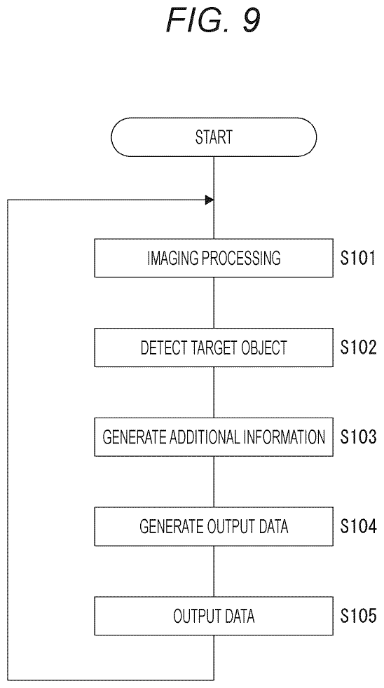

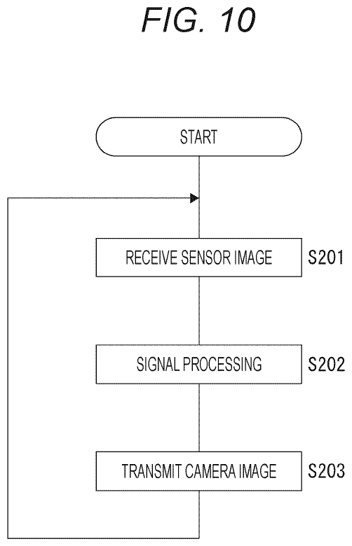

FIG. 9 illustrates an example of processing executed by the sensor device 1 in the camera device 2, and FIG. 10 illustrates an example of processing executed by the external sensor processing unit 4 in the camera device 2.

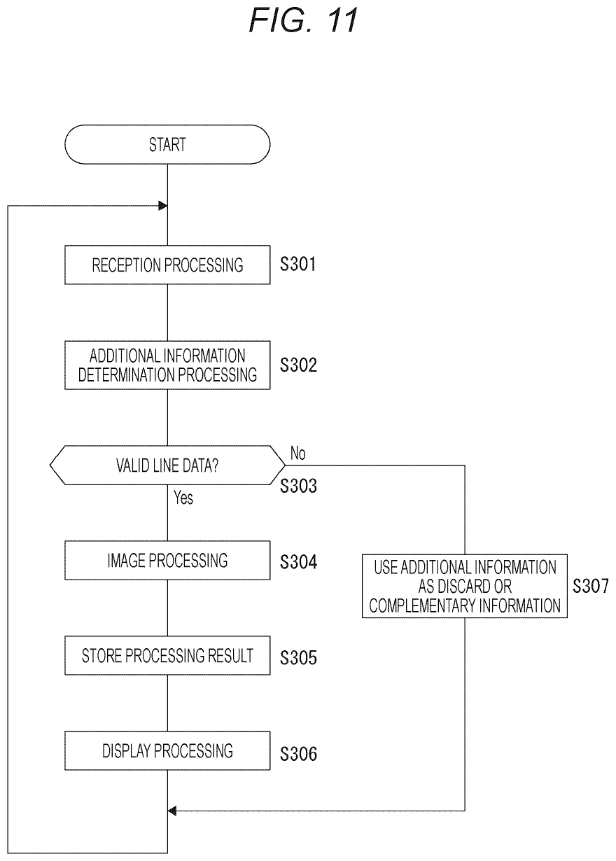

Furthermore, FIG. 11 illustrates an example of processing executed by the information processing device 3 which is a device in a subsequent stage of the camera device 2.

Note that, each processing illustrated in FIGS. 9 and 10 is processing executed for every imaging of the frame image FG repeated from the start of movement to the stop of movement of the detection system S. Furthermore, FIG. 11 illustrates processing repeated from the start of operation to the stop of the movement of the detection system S, and is processing executed a plurality of times by the number of pieces of line data LD for the imaging of the frame image FG.

The imaging unit 5 of the sensor device 1 of the camera device 2 performs imaging processing in step S101 of FIG. 9.

After the imaging processing is ended, the detection processing unit 6 of the sensor device 1 performs target object detection processing in step S102. The processing of detecting the target object OB is performed, for example, for every pixel block region Ar on the basis of the average luminance value as described above.

The additional information generation unit 7 of the sensor device 1 performs processing of generating the additional information AD in step S103.

In step S104, the output data generation unit 8 of the sensor device 1 generates output data (packet data and data of the sensor image) by using the line data LD and the additional information AD.

In step S105, the output unit 9 of the sensor device 1 outputs the output data to the external sensor processing unit 4 in the subsequent stage.

Subsequently, the sensor image receiving unit 10 of the external sensor processing unit 4 of the camera device 2 receives the sensor image in step S201 of FIG. 10.

The camera signal processing unit 11 of the external sensor processing unit 4 performs signal processing in step S202. This signal processing is the above-described synchronization processing, YC generation processing, or the like.

In step S203, the camera image transmitting unit 12 of the external sensor processing unit 4 transmits a camera image to the information processing device 3 as a device in a subsequent stage.

The reception processing unit 13 of the information processing device 3 performs processing of receiving the camera image in step S301 of FIG. 11. Specifically, data including one line data LD in the camera image is received.

The determination processing unit 14 of the information processing device 3 extracts the additional information AD corresponding to the line data LD received in step S302, and determines whether or not the received line data LD is the valid line data LDv.

In step S303, the information processing device 3 performs branch processing based on a determination result of the additional information AD. Specifically, in a case where the additional information AD indicates the valid line data LDv, the image processing unit 15 of the information processing device 3 performs image processing in step S304. As described above, this image processing is processing of detecting the target object OB and determining the presence or absence of a problem such as a defect, processing of detecting and reading a two-dimensional code as the target object OB, or the like.

Note that, the processing of step S304 may be executed, for example, after waiting until a series of pixel data is accumulated.

For example, taking the frame image FG illustrated in FIG. 5 as an example, in a case where two target objects OB are captured in the frame image FG, after a plurality of pieces of line data LD obtained by capturing one target object OB is received, image processing of step S304 is performed on a region by the plurality of pieces of line data LD as a target. Then, after the plurality of pieces of line data LD obtained by capturing the other object OB is received, the image processing of step S304 is performed on a region by the plurality of pieces of line data LD again.

Furthermore, the image processing of step S304 may be performed after all the pieces of valid line data LDv in one frame image FG are received.

Subsequently, in step S305, the storage processing unit 16 of the information processing device 3 performs processing of storing a result of the image processing.

Then, in step S306, the display processing unit 17 of the information processing device 3 performs display processing of the result of the image processing and the frame image FG.

On the other hand, in a case where the additional information AD indicates the invalid line data LDi in step S303, the information processing device 3 discards the line data LD received in step S307, or performs processing for using the line data as complementary information in the image processing of step S305 executed for the valid line data LDv.

The processing for using the line data as the complementary information is, for example, processing of storing the received invalid line data LDi in the storage unit.

### 2. Second Embodiment

A configuration of a camera device 2A of a detection system SA according to a second embodiment is similar to that of the camera device 2 illustrated in FIG. 1. Accordingly, the redundant description is avoided by describing only differences.

The camera device 2A includes a sensor device 1A and an external sensor processing unit 4A.

A detection processing unit 6A of the sensor device 1A not only specifies, for every line data LD, whether or not the pixel data obtained by capturing the target object OB that is a target of image processing in a subsequent stage is included, but also specifies a range that is a target of the image processing in the line data LD as a valid range Rv and a range that is not a target of the image processing as an invalid range Ri.

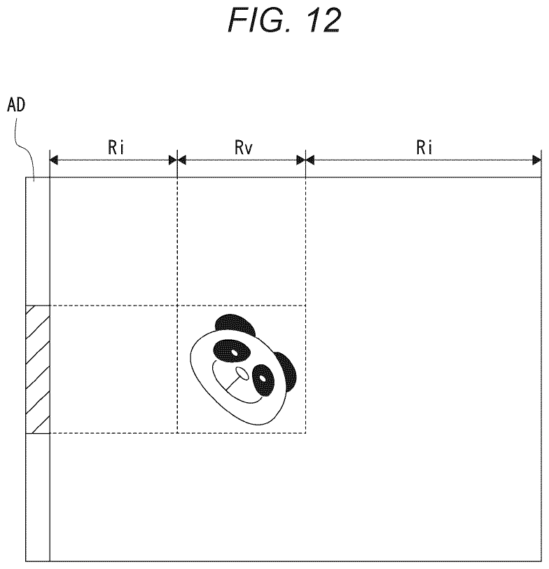

Specifically, for example, as illustrated in FIG. 12, additional information AD for distinguishing between the valid line data LDv and the invalid line data LDi for every line data LD is generated by the additional information generation unit 7.

Furthermore, the detection processing unit 6A sets a pixel range in which the target object OB is captured in the valid line data LDv as the valid range Rv, and sets a pixel range in which the target object OB is not captured as the invalid range Ri.

The valid range Rv and the invalid range Ri are different for every line data LD. Furthermore, the valid range Rv is not set for the invalid line data LDi.

Furthermore, the setting of the valid range Rv and the invalid range Ri may be performed for every pixel block region Ar described above.

Information for specifying the valid range Rv and the invalid range Ri is output from the sensor device 1A to the external sensor processing unit 4A together with the line data LD and the additional information AD. The information for specifying the valid range Rv and the invalid range Ri may be, for example, information for specifying a pixel at a boundary between the valid range Rv and the invalid range Ri, information indicating the pixel block region Ar belonging to the valid range Rv (or the invalid range Ri), or information indicating a start pixel of the valid range Rv and the number of pixels included in the valid range Rv.

Here, an example will be given.

A synchronization signal synchronized with the transmission of the line data LD is supplied from the sensor device 1A to the external sensor processing unit 4A.

The external sensor processing unit 4A can determine the valid range Rv and the invalid range Ri in the line data LD on the basis of the received synchronization signal.

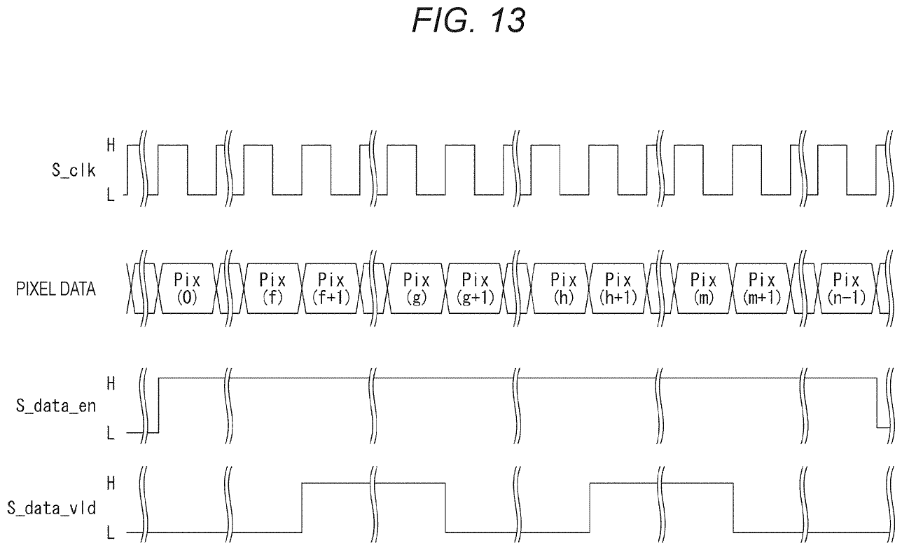

Such determination will be specifically described with reference to FIG. 13.

The output unit 9 of the sensor device 1A outputs a pixel clock signal S_clk, packet data, a pixel data enable signal S_data_en, and a valid data signal S_data_vld to the external sensor processing unit 4A. FIG. 13 is a timing chart illustrating a period during which the pixel data of the packet data is transmitted.

The number of pieces of pixel data included in the line data LD is n. Each pixel data is indicated as Pix (0) to Pix (n−1) in the drawing.

Furthermore, the valid range Rv in the line data LD is a range from Pix (f+1) to Pix (g) and a range from Pix (h+1) to Pix (m).

That is, the invalid range Ri is a range from Pix (0) to Pix (f), a range from Pix (g+1) to Pix (h), and a range from Pix (m+1) to Pix (n−1).

During the transmission of the line data LD stored in the payload region in the packet data, the pixel data enable signal S_data_en is set to 1 (High), and the other signals are set to 0 (Low).

Furthermore, the valid data signal S_data_vld is set to 1 (High) during the transmission of the pixel data in the valid range Rv, and the valid data signal S_data_vld is set to 0 (Low) during the transmission of the pixel data in the invalid range Ri.

The sensor image receiving unit 10 of the external sensor processing unit 4A receives the pixel clock signal S_clk, the pixel data enable signal S_data_en, and the valid data signal S_data_vld together with the packet data, and obtains the line data LD and the additional information AD. The line data LD and the additional information AD obtained here are provided to the information processing device 3A via a camera image transmitting unit 12A.

A reception processing unit 13A of the information processing device 3A provides the received line data LD and additional information AD to the storage processing unit 16, and further provides information regarding the valid range Rv in the line data LD to the storage processing unit 16.

Furthermore, information for specifying the line data LD, the additional information AD, and the valid range Rv is supplied from the reception processing unit 13A to a determination processing unit 14A.

The determination processing unit 14A determines a line to be subjected to image processing by using the additional information AD for every line data LD related to the supplied camera image data. Moreover, the determination processing unit 14A determines the valid range Rv of the valid line data LDv.

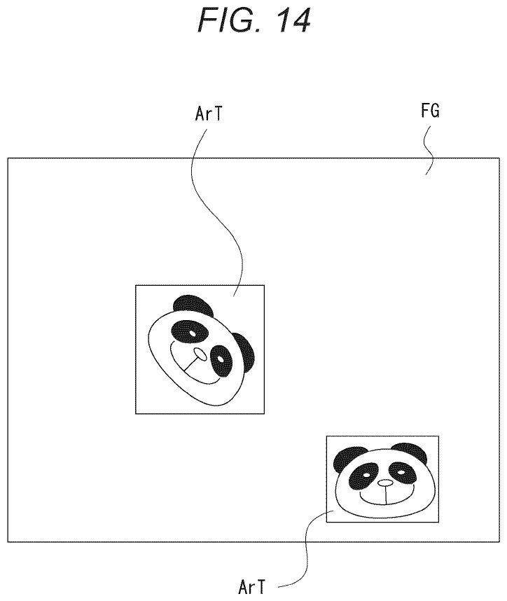

That is, the determination processing unit 14A performs processing of specifying a rectangular processing target region ArT as a target of the image processing in the subsequent stage (see FIG. 14) .

An image processing unit 15A obtains a desired result by performing image processing on the processing target region ArT specified by the determination processing unit 14A. In other words, the image processing unit 15A does not perform image processing on the invalid line data LDi or image processing for the invalid range Ri in the valid line data LDv.

The result obtained by the image processing is stored or presented to the user by being provided to the storage processing unit 16 or the display processing unit 17.

### 3. Third Embodiment

In the above-described example, the image processing unit 15 that performs predetermined image processing is provided in the information processing device 3 (3A) in the subsequent stage of the camera device 2 (2A). In a detection system SB according to the present embodiment, a camera device 2B includes an image processing unit 15B.

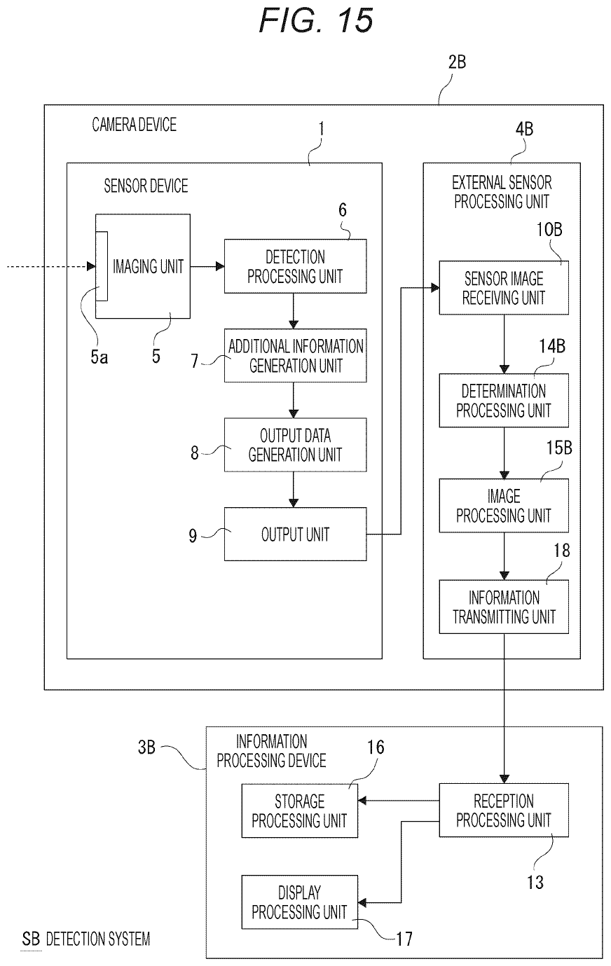

A configuration example of the detection system SB is illustrated in FIG. 15. Note that, configurations similar to those in the first and second embodiments are denoted by the same reference signs, and description thereof will be omitted as appropriate.

The detection system SB includes the camera device 2B and an information processing device 3B. The information processing device 3B is a device for presenting an image processing result to the user.

The camera device 2B includes the sensor device 1 and an external sensor processing unit 4B.

The sensor device 1 includes the imaging unit 5, the detection processing unit 6, the additional information generation unit 7, the output data generation unit 8, and the output unit 9. Aspects of the units are similar to those of the first embodiment. That is, the sensor device 1 outputs the output data OD (sensor image data) that is data conforming to a predetermined standard and includes the line data LD and the additional information AD.

The external sensor processing unit 4B includes a sensor image receiving unit 10B, a determination processing unit 14B, the image processing unit 15B, and the information transmitting unit 18.

The sensor image receiving unit 10B receives the output data OD output from the sensor device 1, and supplies the output data OD to the determination processing unit 14B in the subsequent stage.

The determination processing unit 14B determines the valid line data LDv set as the image processing target by using the additional information AD for every line data LD related to the supplied sensor image.

The determination processing unit 14B supplies information of the valid line data LDv to the image processing unit 15B in the subsequent stage to urge image processing for the valid line data LDV.

The image processing unit 15B obtains a desired result by performing image processing on the valid line data LDv specified by the determination processing unit 14B. Furthermore, the image processing unit 15B avoids image processing on the invalid line data LDi.

Note that, the invalid line data LDi that is not the target of the image processing may be discarded by the determination processing unit 14B or the like, or may be used as the complementary data of the image processing of the valid line data LDv.

The processing result by the image processing unit 15B and partial image data of the valid line data LDv to be processed are transmitted to the information transmitting unit 18.

The information transmitting unit 18 transmits the information received from the image processing unit 15B to the information processing device 3B. Note that, the information transmitting unit 18 may transmit the entire sensor image related to the frame to the information processing device 3B.

The information processing device 3B includes the reception processing unit 13, the storage processing unit 16, and the display processing unit 17.

The reception processing unit 13 supplies the partial image data of the valid line data LDv received from the camera device 2B and information of a result of the image processing to the storage processing unit 16 to store the partial image data and the information in the storage unit. Furthermore, the reception processing unit 13 supplies the information received from the camera device 2B to the display processing unit 17 to realize presentation processing for the user.

A flow of processing in the third embodiment will be described. The sensor device 1 of the camera device 2B performs detection of the target object OB, generation of the additional information AD, generation of the output data OD, and the like by executing each processing of steps S101 to S105 illustrated in FIG. 9.

Furthermore, the external sensor processing unit 4B of the camera device 2B performs each processing of steps S301, S302, S303, S304, and S307 illustrated in FIG. 11 to perform image processing for a partial region in the frame image FG.

Moreover, the information processing device 3B performs information storage processing and presentation processing to the user by timing each processing of steps S305 and S306 illustrated in FIG. 11.

### 4. Modification

The detection system S (SA or SB) in the above-described example performs processing of determining a processing target region inside the sensor device 1 (1A). Accordingly, the data output from the sensor device 1 (1A) may be only the pixel data of the range determined as the valid line data LDv or the valid range Rv in the frame image FG.

Therefore, the amount of communication required for transmission and reception of the pixel data is reduced, and a processing load can be reduced and a communication band can be effectively used.

Furthermore, in the first embodiment, the camera device 2 and the information processing device 3 are described as separate devices, but other aspects are also conceivable.

For example, the camera device 2 may be a camera module including the sensor device 1 and the external sensor processing unit 4, the information processing device 3 may be an external module processing unit provided outside the camera module, and the camera module and the external module processing unit may be provided in one device.

### 5. Summary

As described in each of the examples described above, the sensor device 1 (1A) includes the pixel array unit 5a in which the pixels are two-dimensionally arrayed; the detection processing unit 6 (6A) that determines, for every line data LD output from the pixel array unit 5a, whether or not the line data LD is the valid line data LDv to be processed in the image processing in the subsequent stage, the additional information generation unit 7 that generates the additional information AD on the basis of the result of determination by the determination processing unit (detection processing unit 6 or 6A), the output data generation unit 8 that generates the output data OD for every line by using the line data LD and the additional information AD, and the output unit 9 that outputs the output data OD.

Therefore, it is possible to determine whether or not to perform the image processing for every line data LD in the image processing unit 15 (15A or 15B) in the subsequent stage.

Accordingly, the image processing for the invalid line data LDi can be avoided, and the processing load can be reduced. Furthermore, the image processing is performed only on the valid line data LDv, and thus, it becomes easy to cope with output at a high frame rate. Suitable image processing for the object moving at a high speed (target object OB) can be realized.

Note that, the camera device 2 (2A or 2B) including the sensor device 1 (1A) described above can also be regarded as the sensor device of the present technology.

As described with reference to each of FIGS. 5 to 8, in the sensor device 1 (1A), the additional information AD may be flag information for every line data LD.

Therefore, the data amount of the additional information AD is minimized. Accordingly, an increase in the data amount of the output data OD can be suppressed, and the processing load in the image processing unit 15 (15A or 15B) in the subsequent stage can be reduced.

As described with reference to each of FIGS. 5 to 7, the output data generation unit 8 in the sensor device 1 (1A) may store the additional information AD in the region (for example, packet header region) different from the region (for example, payload region) in which the line data LD is stored and generate the output data OD.

Therefore, the line data LD and the additional information AD can be transmitted separately. Accordingly, the line data LD can be used in the image processing in the subsequent stage without being partially missing.

As described with reference to each of FIGS. 5 to 7, the output data generation unit 8 in the sensor device 1 (1A) may adopt the header region (header region of the packet data) as the different region in which the additional information AD is stored.

Therefore, the additional information AD can be transmitted without increasing the size of the payload region in which the line data LD is stored.

Furthermore, the additional information AD is stored in the unused region or the extended region in the header region, it is not necessary to change the header size, and an increase in the data size of the packet data can be suppressed.

As described with reference to FIG. 8 and the like, the output data generation unit 8 in the sensor device 1 (1A) may generate the output data OD by including the additional information AD in a part of the line data LD.

Therefore, it is possible to transmit both the line data LD and the additional information AD without changing the configuration of the header or the configuration of the payload region.

As described with reference to FIG. 8 and the like, the output data generation unit 8 in the sensor device 1 (1A) may include the additional information AD in the pixel data of the head pixel in the line data LD.

Among the pieces of pixel data included in the line data LD, the pixel data of the head pixel is pixel data in which there is a high possibility that the target object OB is not captured. The additional information AD is included in such pixel data, and thus, the additional information AD can be included in the packet data while minimizing the influence on the image processing in the subsequent stage.

Furthermore, it is possible to prevent the increase in the size of the packet data due to the inclusion of the additional information AD.

Note that, the additional information AD may be included in the pixel data of the last pixel in the line data LD.

However, the additional information AD is included in the pixel data of the head pixel, and thus, it is possible to determine whether or not the remaining data of the line data LD is unnecessary at the stage of reading a head portion of the line data LD.

Accordingly, it is possible to reduce a processing load related to analysis processing of the line data LD.

Furthermore, in particular, the additional information AD is flag information including 1 bit, and thus, only 1-bit information of the pixel data is used as the flag information. As a result, it is possible to reduce the influence on the image. Then, the additional information AD is embedded in a least significant bit (LSB) in the head pixel, and thus, missing of image information can be minimized.

As described with reference to FIGS. 12 to 14 and the like, the determination processing unit (detection processing unit 6 or 6A) in the sensor device 1 (1A) may determine the valid range Rv and the invalid range Ri in the line data LD determined as the valid line data LDv, and the output unit 9 may output a first synchronization signal (pixel data enable signal S_data_en) synchronized with the line data LD in the output data OD and a second synchronization signal (valid data signal S_data_vld) synchronized with an output timing of the data in the valid range Rv and the invalid range Ri.

Therefore, the image processing unit 15 (15A or 15B) in the subsequent stage can specify the valid range Rv and the invalid range Ri in the line data LD on the basis of the input second synchronization signal (valid data signal S_data_vld).

Accordingly, the image processing can be performed more efficiently.

As described with reference to FIGS. 3, 4, and the like, the determination processing unit (detection processing unit 6 or 6A) in the sensor device 1 (1A) may determine, for every pixel block region Ar including a plurality of pixels in each of a row direction and a column direction, whether or not the block is the valid block Bv to be subjected to the image processing in the subsequent stage, and determine the line data LD including a part of the valid block Bv as the valid line data LDv.

Therefore, the validity or invalidity determination can be performed with higher accuracy than that performed for every line. Accordingly, it is possible to reduce a possibility of performing unnecessary image processing in the image processing unit 15 (15A or 15B) in the subsequent stage, and it is possible to reduce the processing load.

As described with reference to FIGS. 3 and 4 and the like, the determination processing unit (detection processing unit 6 or 6A) in the sensor device 1 (1A) may calculate the average luminance value of the pixel block region Ar and perform determination for the valid block Bv.

For example, in a case where a system for detecting a defective product in a situation where the product flows on the belt conveyor is considered, the average luminance value for the pixel block region Ar in which the product appears is different from the average luminance value for the pixel block region Ar in which only the belt conveyor appears.

Accordingly, the pixel block region Ar to be processed can be determined by simple processing. Therefore, it is possible to perform efficient image processing in the image processing unit 15 (15A or 15B) in the subsequent stage while suppressing the increase in the processing load in the sensor device.

As described with reference to FIGS. 3, 4, and the like, the determination processing unit (detection processing unit 6 or 6A) in the sensor device 1 (1A) may calculate a change in the average luminance value between frames and perform determination for the valid block Bv.

Therefore, the pixel block region Ar in which the average luminance value is changed is determined as the valid block Bv.

Accordingly, efficient detection of the valid block Bv can be realized.

As described with reference to FIGS. 3 and 4 and the like, the determination processing unit (detection processing unit 6 or 6A) in the sensor device 1 (1A) may determine the pixel block region Ar as the valid block Bv in a case where the calculated change in the average luminance value between the frames is a change in a predetermined direction.

The direction of change is considered to be a positive direction in which the luminance value increases and a negative direction in which the luminance value decreases. For example, considering a situation where a product other than black flows on a black belt conveyor, a change direction for the pixel block region Ar in which the product newly appears is the positive direction in which the luminance value increases, and a conversion direction for the pixel block region Ar in which the product passes and is changed to a state where only the belt conveyor appears is the negative direction in which the luminance value decreases.

In such a case, the valid block Bv to be subjected to image processing by the image processing unit 15 (15A or 15B) in the subsequent stage is the pixel block region Ar in which a change in the positive direction in which the luminance value increases is observed.

Accordingly, the valid block Bv is determined in a case where the change between the frames is the change in the predetermined direction, and thus, it is possible to reduce the pixel block region Ar to be subjected to the image processing in the subsequent stage and to reduce the processing load.

Note that, in a case where a dark product flows on a white belt conveyor, a similar effect can be obtained by setting the pixel block region Ar in which the change direction of the average luminance value is the negative direction as the valid region.

As described with reference to FIGS. 12 to 14 and the like, the determination processing unit (detection processing unit 6 or 6A) in the sensor device 1 (1A) may determine the valid range Rv and the invalid range Ri in the line data LD determined as the valid line data LDv, and determine a range included in the valid block Bv in the valid line data LDv as the valid range Rv.

Therefore, it is possible to identify the valid range Rv to be processed in the line data LD and the other ranges in the image processing unit 15 (15A or 15B) in the subsequent stage while making the granularity of determination for the valid pixel range and the invalid pixel range finer than that for every line. Accordingly, it is possible to narrow the range taken as the measure for the image processing in the subsequent stage and to reduce the processing load.

A data structure of the present technology is a data structure of the output data OD output from the sensor device 1 (1A) including the pixel array unit 5a in which the pixels are two-dimensionally arrayed, and is generated on the basis of the line data LD output from the pixel array unit 5a and the additional information AD indicating the determination result as to whether the line data LD is the valid line data LDv to be processed in the image processing in the subsequent stage for every line data LD.

By using such a data structure, it is possible to distinguish the line data LD to be processed and the line data LD not to be processed in the information processing device having received the information.

Accordingly, it is possible to reduce the burden of the image processing in the subsequent stage and to shorten a processing time.

As described with reference to FIGS. 1, 15, and the like, the information processing device 3 (3A) of the present technology or the external sensor processing unit 4B as the information processing device includes the reception processing unit 13 or 13A (or the sensor image receiving unit 10B) that receives, from the sensor device 1 (1A), the output data OD generated on the basis of the line data LD output from the pixel array unit 5a in which the pixels are two-dimensionally arrayed and the additional information AD indicating the determination result as to whether or not the line data LD is the valid line data LDv to be processed in the subsequent stage of the image processing for every line data LD, the determination processing unit 14 (14A or 14B) that determines whether or not to execute predetermined image processing for the line data LD on the basis of the additional information AD included in the output data OD received by the reception processing unit 13 or 13A (or the sensor image receiving unit 10B), and the execution processing unit (image processing unit 15, 15A, or 15B) that executes predetermined image processing for the line data LD on the basis of the determination result of the determination processing unit 14 (14A or 14B).

Therefore, it is possible to distinguish the line data LD as the image processing target in the information processing device 3 (3A) or the external sensor processing unit 4B as the information processing device.

Accordingly, necessary image processing can be reliably executed.

As described with reference to FIGS. 1, 15, and the like, the execution processing unit (image processing unit 15, 15A, or 15B) in the information processing device 3 (3A) of the present technology or the external sensor processing unit 4B as the information processing device does not need to execute predetermined image processing for the line data LD in a case where it is determined that the line data LD is not the valid line data LDv on the basis of the additional information AD corresponding to the line data LD.

Therefore, since the data targeted for the image processing can be limited to a part, it is possible to reduce the processing load of the information processing device.

Furthermore, the image processing is performed only on the valid line data LDv, and thus, it becomes easy to cope with output at a high frame rate. As a result, suitable image processing for an object moving at a high speed can be realized.

As described with reference to FIGS. 11, 15, and the like, the determination processing unit 14 (14A or 14B) of the information processing device 3 (3A) of the present technology or the external sensor processing unit 4B as the information processing device may discard the line data LD in a case where it is determined that the line data LD is not the valid line data LDv on the basis of the additional information AD corresponding to the line data LD.

Therefore, since only a part of the line data LD is only required to be stored, a storage region can be effectively used.

Note that, the effects described in the present specification are merely examples and are not limited, and furthermore, other effects may be provided.

Furthermore, the above-described examples may be combined in any way, and the above-described various actions and effects may be obtained even in a case where various combinations are used.

### 6. Present Technology

The present technology can also adopt the following configurations.
(1)

A sensor device including:
a pixel array unit in which pixels are two-dimensionally arrayed;
a determination processing unit that determines whether or not every line data output from the pixel array unit is valid line data to be processed in image processing in a subsequent stage;
an additional information generation unit that generates additional information on a basis of a result of the determination by the determination processing unit;
an output data generation unit that generates output data for every line by using the line data and the additional information; and
an output unit that outputs the output data.
(2)

The sensor device according to the above (1),
in which the additional information is flag information for every line data.
(3)

The sensor device according to the above (1) or (2), in which the output data generation unit generates the output data by storing the additional information in a region different from a region in which the line data is stored.
(4)

The sensor device according to the above (3),
in which the output data generation unit sets the different region as a header region.
(5)

The sensor device according to the above (1) or (2),
in which the output data generation unit generates the output data by including the additional information in a part of the line data.
(6)

The sensor device according to the above (5),
in which the output data generation unit includes the additional information in pixel data of a head pixel in the line data.
(7)

The sensor device according to any one of the above (1) to (6),
in which the determination processing unit determines a valid range and an invalid range in the line data determined as the valid line data, and
the output unit outputs a first synchronization signal synchronized with the line data in the output data and a second synchronization signal synchronized with an output timing of data in the valid range and the invalid range.
(8)

The sensor device according to any one of the above (1) to (7),
in which the determination processing unit determines whether or not every pixel block region including a plurality of pixels in each of a row direction and a column direction is a valid block to be processed in the image processing in the subsequent stage, and determines the line data including a part of the valid block as the valid line data.
(9)

The sensor device according to the above (8),
in which the determination processing unit calculates an average luminance value of the pixel block region and performs determination for the valid block.
(10)

The sensor device according to the above (9),
in which the determination processing unit calculates a change in the average luminance value between frames and performs determination for the valid block.
(11)

The sensor device according to the above (10), in which the determination processing unit determines the pixel block region as the valid block in a case where the calculated change between the frames is a change in a predetermined direction.
(12)

The sensor device according to the above (11),
in which the determination processing unit determines a valid range and an invalid range in the line data determined as the valid line data, and determines a range of the valid line data, which is included in the valid block, as the valid range.
(13)

A data structure of output data output from a sensor device including a pixel array unit in which pixels are two-dimensionally arrayed,
the data structure
being generated on a basis of line data output from the pixel array unit and additional information indicating a determination result as to whether every line data is valid line data to be processed in image processing in a subsequent stage.
(14)

An information processing device including:
a reception processing unit that receives, from a sensor device, output data generated on a basis of line data output from a pixel array unit in which pixels are two-dimensionally arrayed, and additional information indicating a determination result as to whether every line data is valid line data to be processed in image processing in a subsequent stage;
a determination processing unit that determines whether or not to execute predetermined image processing for the line data on a basis of the additional information included in the output data received by the reception processing unit; and
an image processing unit that executes the predetermined image processing for the line data on a basis of a determination result of the determination processing unit.
(15)

The information processing device according to the above (14),
in which the image processing unit does not execute the predetermined image processing for the line data in a case where it is determined that the line data is not the valid line data on a basis of the additional information corresponding to the line data.
(16)

The information processing device according to the above (14) or (15),
in which the determination processing unit discards the line data in a case where it is determined that the line data is not the valid line data on a basis of the additional information corresponding to the line data.

### REFERENCE SIGNS LIST

1, 1A Sensor device
3, 3A Information processing device
4B External sensor processing unit (information processing device)
5a Pixel array unit
6, 6A Detection processing unit
7 Additional information generation unit
8 Output data generation unit
9 Output unit
10B Sensor image receiving unit (reception processing unit)
13, 13A Reception processing unit
14, 14A, 14B Determination processing unit
15, 15A, 15B Image processing unit (execution processing unit)
LD Line data
LDV Valid line data
Ar, Ar1, Ar2 Pixel block region
AD Additional information
OD Output data
Bv Valid block
Rv Valid range
Ri Invalid range

1. A sensor device comprising:
a pixel array unit in which pixels are two-dimensionally arrayed;
a determination processing unit that determines whether or not every line data output from the pixel array unit is valid line data to be processed in image processing in a subsequent stage;
an additional information generation unit that generates additional information on a basis of a result of the determination by the determination processing unit;
an output data generation unit that generates output data for every line by using the line data and the additional information; and
an output unit that outputs the output data.

2. The sensor device according to claim 1,
wherein the additional information is flag information for every line data.

3. The sensor device according to claim 1,
wherein the output data generation unit generates the output data by storing the additional information in a region different from a region in which the line data is stored.

4. The sensor device according to claim 3,
wherein the output data generation unit sets the different region as a header region.

5. The sensor device according to claim 1,
wherein the output data generation unit generates the output data by including the additional information in a part of the line data.

6. The sensor device according to claim 5,
wherein the output data generation unit includes the additional information in pixel data of a head pixel in the line data.

7. The sensor device according to claim 1,
wherein the determination processing unit determines a valid range and an invalid range in the line data determined as the valid line data, and
the output unit outputs a first synchronization signal synchronized with the line data in the output data and a second synchronization signal synchronized with an output timing of data in the valid range and the invalid range.

8. The sensor device according to claim 1,
wherein the determination processing unit determines whether or not every pixel block region including a plurality of pixels in each of a row direction and a column direction is a valid block to be processed in the image processing in the subsequent stage, and determines the line data including a part of the valid block as the valid line data.

9. The sensor device according to claim 8,
wherein the determination processing unit calculates an average luminance value of the pixel block region and performs determination for the valid block.

10. The sensor device according to claim 9,
wherein the determination processing unit calculates a change in the average luminance value between frames and performs determination for the valid block.

11. The sensor device according to claim 10,
wherein the determination processing unit determines the pixel block region as the valid block in a case where the calculated change between the frames is a change in a predetermined direction.

12. The sensor device according to claim 11,
wherein the determination processing unit determines a valid range and an invalid range in the line data determined as the valid line data, and
determines a range of the valid line data, which is included in the valid block, as the valid range.

13. A data structure of output data output from a sensor device including a pixel array unit in which pixels are two-dimensionally arrayed,
the data structure
being generated on a basis of line data output from the pixel array unit and additional information indicating a determination result as to whether every line data is valid line data to be processed in image processing in a subsequent stage.

14. An information processing device comprising:
a reception processing unit that receives, from a sensor device, output data generated on a basis of line data output from a pixel array unit in which pixels are two-dimensionally arrayed, and additional information indicating a determination result as to whether every line data is valid line data to be processed in image processing in a subsequent stage;
a determination processing unit that determines whether or not to execute predetermined image processing for the line data on a basis of the additional information included in the output data received by the reception processing unit; and
an image processing unit that executes the predetermined image processing for the line data on a basis of a determination result of the determination processing unit.

15. The information processing device according to claim 14,
wherein the image processing unit does not execute the predetermined image processing for the line data in a case where it is determined that the line data is not the valid line data on a basis of the additional information corresponding to the line data.

16. The information processing device according to claim 14,
wherein the determination processing unit discards the line data in a case where it is determined that the line data is not the valid line data on a basis of the additional information corresponding to the line data.
